(19) United States
(12) Patent Application Publication
(10) Pub. No.: US 2025/0022441 A1
(43) Pub. Date: Jan. 16, 2025

(54) METHOD, DEVICE, AND ELECTRONIC EQUIPMENT FOR DETERMINING THE DROP DEPTH OF SCREEN LEAKAGE LIGHT

(71) Applicant: Shenzhen Goodix Technology Co., Ltd., Shenzhen (CN)

(72) Inventor: Xiangyu YANG, Shenzhen (CN)

(21) Appl. No.: 18/895,779

(22) Filed: Sep. 25, 2024

Related U.S. Application Data
(63) Continuation of application No. PCT/CN2023/118032, filed on Sep. 11, 2023.

(30) Foreign Application Priority Data
Sep. 30, 2022 (CN) 202211209421.6

(51) Int. Cl. G09G 5/393

(52) U.S. Cl. CPC G09G 5/393; G09G 2320/045; G09G 2360/144

(57) ABSTRACT

A method, a device and an electronic equipment for determining the drop depth of screen leakage light, the method comprising: obtaining a sampling data based on a vertical synchronization signal; determining a first sampling sequence, as well as a second sampling sequence and/or a third sampling sequence based on the sampling data, the first sampling sequence is the sampling sequence of the drop zone of the screen leakage light drop waveform, the second sampling sequence is the sampling sequence on the left side of the drop zone of the screen leakage light drop waveform, and the third sampling sequence is the sampling sequence on the right side of the drop zone of the screen leakage light drop waveform; determining the drop depth based on the first sampling sequence, as well as the second sampling sequence and/or the third sampling sequence.

### CROSS-REFERENCE TO RELATED APPLICATIONS

This application is a continuation application of International Application No. PCT/CN2023/118032, filed on Sep. 11, 2023, which claims priority to Chinese patent application filed with the Chinese Patent Office on Sep. 30, 2022, with application number 202211209421.6 and invention name “METHOD, DEVICE, AND ELECTRONIC EQUIPMENT FOR DETERMINING THE DROP DEPTH OF SCREEN LEAKAGE LIGHT”, the entire content of which is incorporated herein by reference.

### TECHNICAL FIELD

This application relates to the field of ambient light detection technology, and more specifically, to a method, a device, and an electronic equipment for determining the drop depth of screen leakage light.

### BACKGROUND

In pursuit of a better user experience, full-screen displays have become a development trend in mobile terminals such as electronic equipment, leading various components inside electronic equipment to develop under the screen.

Under-screen optical sensors can detect the ambient light of the environment in which the electronic equipment is located, enabling the electronic equipment to achieve functions such as screen brightness self-adjustment based on ambient light. However, ambient light detection must eliminate the influence of screen leakage light, as screen leakage light has a decisive impact on the accuracy of ambient light detection. Therefore, accurately calculating screen leakage light is an urgent technical problem that needs to be solved.

### SUMMARY

The embodiment of this application provides a method, a device, and an electronic equipment for determining the drop depth of screen leakage light, which can improve the accuracy of screen leakage light calculation, thereby helping to improve the accuracy and reliability of ambient light detection.

In a first aspect, a method for determining the drop depth of screen leakage light is provided, the method comprising: obtaining a sampling data based on a vertical synchronization signal; determining a first sampling sequence, as well as a second sampling sequence and/or a third sampling sequence based on the sampling data, the first sampling sequence is the sampling sequence of the drop zone of the screen leakage light drop waveform, the second sampling sequence is the sampling sequence on the left side of the drop zone of the screen leakage light drop waveform, the third sampling sequence is the sampling sequence on the right side of the drop zone of the screen leakage light drop waveform; determining the drop depth based on the first sampling sequence, as well as the second sampling sequence and/or third sampling sequence.

The detection of ambient light requires the exclusion of screen leakage light influence. Since the drop depth of screen leakage light is independent of ambient light, screen leakage light is typically calculated using a model based on the drop depth of screen leakage light and the amount of leakage light, thus enabling the detection of ambient light. In the embodiment of this application, obtaining a sampling data based on a vertical synchronization signal, allowing the sensor to obtain a sampling data based on the actual screen refresh situation, which reduces noise acquisition and contributes to improving the signal-to-noise ratio of the final calculation result; by collecting data from the drop zone, left side of the drop zone and/or right side of the drop zone of the screen leakage light waveform, it becomes possible to flexibly select data from different areas when determining the drop depth of the screen leakage light waveform, which helps avoid the influence of factors such as ambient light strobing and signal-to-noise ratio of the sensor on drop depth calculation, thereby enhancing the accuracy of screen leakage light calculation; additionally, it mitigate s distortion in screen leakage light calculation in complex environments, which aids in improving the accuracy of ambient light detection.

In one possible implementation, obtaining a sampling data based on the vertical synchronization signal comprises: receiving the vertical synchronization signal sent by the screen, and acquiring the sampling data after a first time delay.

In the embodiment of this application, data collection begins after a first time delay triggered by the vertical synchronization signal. For sensors placed at different positions under the display screen, the first time delay can be adjusted, accordingly, which can improve the consistency of the sampling data.

In one possible implementation, determining a first sampling sequence, as well as a second sampling sequence and/or a third sampling sequence based on the sampling data comprises: filtering the sampling data according to a signal-to-noise ratio requirement; determining the first sampling sequence, as well as the second sampling sequence and/or the third sampling sequence based on the filtered sampling data.

In the embodiment of this application, after obtaining the sampling data, can filter the sampling data according to the signal-to-noise ratio requirement of different equipments or devices, and obtaining the filtered sampling data. By utilizing the filtered sampling data for calculating the drop depth of screen leakage light, it becomes possible to effectively mitigate or eliminate the influence of noise from the equipment or device itself on drop depth calculation, which enhances the accuracy of drop depth calculation and aids in improving the accuracy of ambient light detection.

In one possible implementation, determining a first sampling sequence, as well as a second sampling sequence and/or a third sampling sequence based on the sampling data comprises: determining the filtered sampling data belongs to the first sampling sequence, the second sampling sequence and/or the third sampling sequence based on the time sequence position corresponding to the sampling data.

In one possible implementation, filtering includes mean filtering and median filtering.

In one possible implementation, determining the drop depth based on the first sampling sequence, as well as the second sampling sequence and/or third sampling sequence comprises: determining a drop depth sequence based on the first sampling sequence, as well as the second sampling sequence and/or third sampling sequence; determining the drop depth based on the drop depth sequence.

In the embodiment of this application, by categorizing the sampling data into sampling sequences of the drop zone and sampling sequence of the non-drop zone respectively, it becomes possible to flexibly select different sampling data for drop depth calculation, which enhances the adaptability to the equipment of different models or requirements and improves the flexibility of drop depth calculation.

In one possible implementation, determining the drop depth sequence based on the first sampling sequence, as well as the second sampling sequence and/or the third sampling sequence comprises: determining the drop depth sequence based on the first sampling sequence and the second sampling sequence; alternatively, determining the drop depth sequence based on the first sampling sequence and the third sampling sequence; alternatively, determining the drop depth sequence based on the first sampling sequence, the second sampling sequence and the third sampling sequence.

In one possible implementation, when the drop frequency of the screen leakage light is higher than the ambient light strobing frequency and not in a relationship of multiplicating frequency with it, determining the drop depth sequence based on the first sampling sequence and the second sampling sequence; alternatively, determining the drop depth sequence based on the first sampling sequence and the third sampling sequence.

In one possible implementation, when the drop frequency of the screen leakage light is similar to the ambient light strobing frequency, or, when the drop frequency of the screen leakage light is in a relationship of multiplicating frequency with the ambient light strobing frequency, determining the drop depth sequence based on the first sampling sequence, the second sampling sequence and the third sampling sequence.

In one possible implementation, determining the drop depth sequence based on the first sampling sequence and the second sampling sequence comprises: determining a first maximum value as the average value of the sampling data corresponding to M sampling points near the first time sequence position in the second sampling sequence, wherein M is a positive integer; alternatively, determining a first maximum value as the average value of the sampling data corresponding to M sampling points near the time sequence position which corresponds to the sampling data with the maximum numerical value in the second sampling sequence, wherein M is a positive integer; calculating the difference between the first maximum value and the first sampling sequence to determine the drop depth sequence.

In one possible implementation, determining the drop depth sequence based on the first sampling sequence and the third sampling sequence comprises: determining a second maximum value as the average value of the sampling data corresponding to N sampling points near the second time sequence position in the third sampling sequence, wherein N is a positive integer; alternatively, determining a second maximum value as the average value of the sampling data corresponding to N sampling points near the time sequence position which corresponds to the sampling data with the maximum numerical value in the third sampling sequence, wherein N is a positive integer; calculating the difference between the second maximum value and the first sampling sequence to determine the drop depth sequence.

In one possible implementation, determining the drop depth sequence based on the first sampling sequence, the second sampling sequence and the third sampling sequence comprises: calculating the interpolation operation result of the second sampling sequence and the third sampling sequence at the time sequence position corresponding to the first sampling sequence, which obtains a fourth sampling sequence; calculating the difference between the fourth sampling sequence and the first sampling sequence to determine the drop depth sequence.

In the embodiment of this application, when it is in the complex environments with strobing ambient light, the drop depth sequence can be calculated though interpolation operation. The interpolation operation helps mitigate the influence of strobing ambient light on drop depth calculation, thereby enhancing the accuracy of drop depth calculation in complex environments and improving the accuracy of ambient light detection.

In one possible implementation, the interpolation operation includes linear interpolation operation, cubic spline interpolation operation and polynomial interpolation operation.

In one possible implementation, determining the drop depth based on the drop depth sequence comprises: determining the drop depth based on the fixed data in the drop depth sequence; determining the drop depth based on the changed data in the drop depth sequence.

In one possible implementation, determining the drop depth based on the fixed data in the drop depth sequence comprises: determining the drop depth as all data in the drop depth sequence; alternatively, determining the drop depth as the average value of all data in the drop depth sequence; alternatively, determining the drop depth as the average of m data near the third time sequence position in the drop depth sequence, wherein m is a positive integer; alternatively, obtaining a weight coefficient sequence whose length is corresponding to the length of the drop depth sequence, and determining the drop depth as the average value of the product of each data in the drop depth sequence and that in the corresponding weight coefficient sequence.

In one possible implementation, determining the drop depth by the changed data in the drop depth sequence comprises: determining the drop depth as the average value of the top n data in the drop depth sequence whose values are arranged in descending order, wherein n is a positive integer; alternatively, determining the drop depth as the average value of h data near the time sequence position corresponding to the data with the maximum numerical value in the drop depth sequence, wherein h is a positive integer.

In one possible implementation, when the screen leakage light drop waveform is consistent, determining the drop depth based on the fixed data in the drop depth sequence; alternatively, when the screen leakage light drop waveform is not consistent, determining the drop depth based on the changed data in the drop depth sequence.

In a second aspect, a device for determining the drop depth of screen leakage light is provided, the device comprising: a first sensor, the first sensor is utilized to obtain sampling data based on a vertical synchronization signal; a first processor, the first processor is utilized to determine a first sampling sequence, as well as a second sampling sequence and/or a third sampling sequence based on the sampling data; determining the drop depth based on the first sampling sequence, as well as the second sampling sequence and/or third sampling sequence; herein, the first sampling sequence is the sampling sequence of the drop zone of the screen leakage light waveform, the second sampling sequence is the sampling sequence on the left side of the drop zone of the screen leakage light waveform, the third sampling sequence is the sampling sequence on the right side of the drop zone of the screen leakage light waveform.

In one possible implementation, the first sensor is utilized to receive the vertical synchronization signal sent by the screen, and acquire the sampling data after a first time delay.

In one possible implementation, the first processor is utilized to filter the sampling data according to the signal-to-noise ratio requirement; determining the first sampling sequence, as well as the second sampling sequence and/or the third sampling sequence based on the filtered sampling data.

In one possible implementation, the signal-to-noise ratio requirement includes the signal-to-noise ratio of the screen and the signal-to-noise ratio of the device.

In one possible implementation, the first processor is utilized to determine the filtered sampling data belongs to the first sampling sequence, as well as the second sampling sequence and/or the third sampling sequence based on the time sequence position corresponding to the sampling data.

In one possible implementation, filtering includes mean filtering and median filtering.

In one possible implementation, the first processor is utilized to determine the drop depth sequence based on the first sampling sequence, as well as the second sampling sequence and/or the third sampling sequence; determining the drop depth based on the drop depth sequence.

In one possible implementation, the first processor is utilized to determine the drop depth sequence based on the first sampling sequence and the second sampling sequence; alternatively, the first processor is utilized to determines the drop depth sequence based on the first sampling sequence and the third sampling sequence; alternatively, the first processor is utilized to determine the drop depth sequence based on the first sampling sequence, the second sampling sequence and the third sampling sequence.

In one possible implementation, when the drop frequency of the screen leakage light is higher than the ambient light strobing frequency and not in a relationship of multiplicating frequency with the ambient light strobing frequency, the first processor is utilized to determine the drop depth sequence based on the first sampling sequence and the second sampling sequence; alternatively, determine the drop depth sequence based on the first sampling sequence and the third sampling sequence.

In one possible implementation, when the drop frequency of the screen leakage light is similar to the ambient light strobing frequency and in a relationship of multiplicating frequency with the ambient light strobing frequency, the first processor is utilized to determine the drop depth sequence based on the first sampling sequence, the second sampling sequence and the third sampling sequence.

In one possible implementation, the first processor is utilized to determine a first maximum value as the average value of the sampling data corresponding to M sampling points near the first time sequence position in the second sampling sequence, and calculate the difference between the first maximum value and the first sampling sequence to determine the drop depth sequence, wherein M is a positive integer; alternatively, the first processor is utilized to determine a first maximum value as the average value of the sampling data corresponding to M sampling points near the time sequence position of the sampling data with the maximum numerical value in the second sampling sequence, and calculate the difference between the first maximum value and the first sampling sequence to determine the drop depth sequence, wherein M is a positive integer.

In one possible implementation, the first processor is utilized to determine a second maximum value as the average value of the sampling data corresponding to N sampling points near the second time sequence position in the third sampling sequence, and calculate the difference between this second maximum value and the first sampling sequence to determine the drop depth sequence, wherein N is a positive integer; alternatively, the first processor is utilized to determine a second maximum value as the average value of the sampling data corresponding to N sampling points near the time sequence position of the sampling data with the maximum numerical value in the third sampling sequence, and calculate the difference between the second maximum value and the first sampling sequence to determine the drop depth sequence, wherein N is a positive integer.

In one possible implementation, the first processor is utilized to calculate the interpolation operation result of the first sampling sequence and the third sampling sequence at the time sequence position corresponding to the second sampling sequence, which obtains a fourth sampling sequence; and calculate the difference between the fourth sampling sequence and the first sampling sequence to determine the drop depth sequence.

In one possible implementation, the interpolation operation includes linear interpolation operation, cubic spline interpolation operation, and polynomial interpolation operation.

In one possible implementation, determining the drop depth based on the drop depth sequence comprises: the first processor is utilized to determine the drop depth by the fixed data in the drop depth sequence; alternatively, the first processor is utilized to determine the drop depth by the changed data in the drop depth sequence.

In one possible implementation, the first processor is utilized to determine the drop depth as all data in the drop depth sequence; alternatively, determine the drop depth as the average value of all data in the drop depth sequence; alternatively, determine the drop depth as the average value of m data near the third time sequence position in the drop depth sequence, wherein m is a positive integer; alternatively, obtain a weight coefficient sequence whose length is corresponding to the length of the drop depth sequence, and determine the drop depth as the average value of the product of each data in the drop depth sequence and that in the corresponding weight coefficient sequence.

In one possible implementation, the first processor is utilized to determine the drop depth as the average value of the top n data in the drop depth sequence whose values are arranged in descending order, wherein n is a positive integer; alternatively, determine the drop depth as the average value of h data near the time sequence position corresponding to the sampling data with the maximum numerical value in the drop depth sequence is the drop depth, wherein h is a positive integer.

In one possible implementation, when the screen leakage light drop waveform is consistent, the first processor is utilized to determine the drop depth based on the fixed data in the drop depth sequence; alternatively, when the screen leakage light drop waveform is not consistent, the first processor is utilized to determine the drop depth based on the changed data in the drop depth sequence.

In a third aspect, a device for detecting ambient light is provided, the device comprising: a second sensor, the second sensor is utilized to obtain collected light data, the collected light data includes ambient light data and screen leakage light data; a second processor, the second processor is utilized to obtain the screen leakage light data and calculate the difference between the collected light data and the screen leakage light data for detecting ambient light, herein, the screen leakage light data is derived from the model based on the drop depth of screen leakage light—the amount of screen leakage light; the device for determining the drop depth of screen leakage light as described in any possible implementation of the second aspect is utilized to detect the drop depth of screen leakage light.

In a fourth aspect, an electronic equipment is provided, the electronic equipment comprises: a display screen, the device for determining the drop depth of screen leakage light as described in any possible implementation of the second aspect is positioned beneath the display screen and is utilized for ambient light detection.

### BRIEF DESCRIPTION OF THE FIGURES

FIG. 1 is a schematic diagram of the dimming period in an embodiment of this application.

FIG. 2 is a schematic flowchart of a method for determining the drop depth of screen leakage light in an embodiment of this application.

FIG. 3 is another schematic flowchart of a method for determining the drop depth of screen leakage light in an embodiment of this application.

FIG. 4 is a schematic diagram of a dimming waveform and sampling points in an embodiment of this application.

FIG. 5 is a schematic diagram of another dimming waveform and sampling points in an embodiment of this application.

FIG. 6 is a schematic structural diagram of a device for determining the drop depth of screen leakage light in an embodiment of this application.

FIG. 7 is a schematic structural diagram of a device for ambient light detection in an embodiment of this application.

FIG. 8 is a schematic structural diagram of an electronic equipment in an embodiment of this application.

### DESCRIPTION OF THE EMBODIMENTS

The technical solution in the embodiments of this application is described in the following in conjunction with the figures.

It should be understood that the terms used in the embodiments and claims of this application are solely for the purpose of describing specific embodiments and are not intended to limit the embodiments of this application. For example, the singular form used in the embodiments of this application and the accompanying claims, such as “a”, “above”, “the”, etc., are also intended to include the plural form, unless the context clearly indicates other meanings.

It should be understood that the reference to “one embodiment” throughout the specification means that specific characteristics, structures or features related to the embodiment are included in at least one embodiment of this application. Therefore, the words “one embodiment” may not necessarily refer to the same embodiment throughout the entire specification. In addition, these specific characteristics, structures or features can be combined in any suitable way in one or more embodiments. It should also be understood that in each embodiment of the application, the sequence number order of each process does not imply the order of execution, the execution order of each process should be determined by its function and internal logic, and should not constitute any limitation on the implementation process of any embodiment of the application.

The optical sensor can detect the ambient light of the environment in which the electronic equipment is located, enabling the electronic equipment to achieve functions such as screen brightness self-adjustment based on the change of ambient light. In order to achieve a higher screen-to-body ratio and full-screen display, components such as the optical sensor, originally located above the screen, have been moved under the screen. Consequently, the detection of ambient light must account for the influence of screen leakage light.

Specifically, the display screen emits light during the display process, since a portion of the screen light is received by a optical sensor, resulting in screen leakage light. Therefore, the light received by the optical sensor set under the screen is the sum of external ambient light and screen leakage light. In other words, the light intensity detected by the optical sensor is the combination of the luminous intensity of the display screen and the ambient light. Hence, in order to accurately measure the ambient light intensity, the light intensity detected by the sensor needs to be adjusted by subtracting the light intensity of the screen leakage light. It can be said that the accuracy of estimating the light intensity of screen leakage light directly determines the precision of ambient light detection.

FIG. 1 shows a schematic diagram of one dimming period of a display screen. Generally, the display screen emits screen light based on its dimming period, the dimming method can be, for example, pulse width modulation (PWM) dimming or direct current (DC) dimming. The luminous power of the display screen is not fixed, it will experience periodic drop over time, therefore, a dimming period includes both drop zone(Blank) and non-drop zone(Non-blank). Here, the drop zone refers to the interval with lower luminous power or lower luminous intensity during the dimming period, such as area a in FIG. 1, where the display screen has less screen leakage light. The non-drop zone refers to the interval with higher luminous power or higher luminous intensity during the dimming period, such as area b in FIG. 1, where the display screen has more screen leakage light. The difference in luminous power or luminous intensity between the non-drop zone and drop zone is referred to as the drop depth. As mentioned above, since the screen leakage light is the screen light received by the optical sensor, therefore, the dimming waveform of the display screen is entirely consistent with the screen leakage light waveform. In other words, the dimming waveform described in this application is the leakage light waveform, the dimming period described in this application is the leakage period, and the drop depth of the dimming waveform of the display screen described in this application is the drop depth of the screen leakage light waveform.

It should be understood that the partitioning of drop zone and non-drop zone in FIG. 1 is only provided as an illustration. In other illustrations, the dimming period may also include a corner zone(Corner) located between the drop zone and non-drop zone.

Since the drop depth of screen leakage light is not affected by ambient light, a common method for detecting the amount of screen leakage light is to establish a relational model of “the drop depth of screen leakage light—the amount of screen leakage light”. Therefore, determination of the drop depth becomes a crucial factor influencing the detection of leakage light, and consequently, becomes a key factor affecting the accuracy of ambient light detection. However, in the actual process of determining the drop depth, affected by ambient light strobing or the signal-to-noise ratio of devices such as sensors or chips, the calculated result of the drop depth can easily lead to inconsist with the true results, resulting in the occurrence of calculation distortion.

Therefore, the embodiments of this application provide a method for determining the drop depth of screen leakage light, which can accurately calculate the drop depth of screen leakage light in complex environments, improve the distortion of drop depth calculation, and thus help enhance the accuracy of ambient light detection.

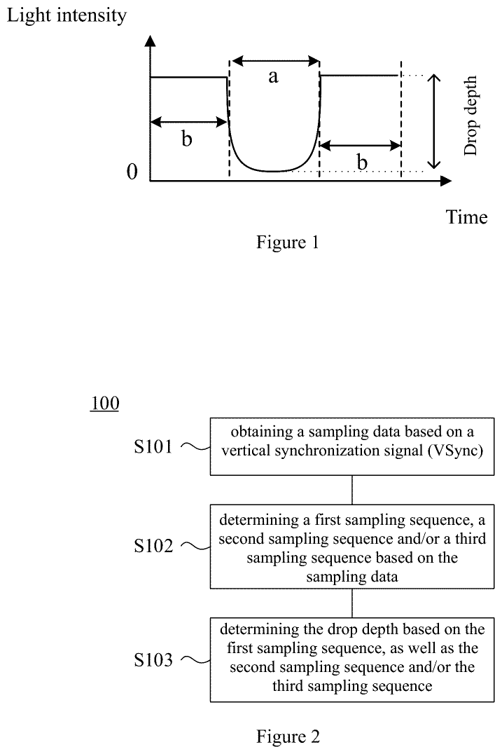

FIG. 2 illustrates a schematic flowchart of a method for determining the drop depth of screen leakage light in an embodiment of this application. As shown in FIG. 2, the method 100 for determining the drop depth of screen leakage light comprises partial or all of the following steps.

In step S101, obtaining a sampling data based on a vertical synchronization signal (VSync).

In step S102, determining a first sampling sequence, a second sampling sequence and/or a third sampling sequence based on the sampling data.

Wherein, the first sampling sequence is the sampling sequence of the drop zone of the screen leakage light drop waveform, the second sampling sequence is the sampling sequence of the left side of the drop zone of the screen leakage light drop waveform, and the third sampling sequence is the sampling sequence of the right side of the drop zone of the screen leakage light drop waveform.

It can be understood that the first sampling sequence, as well as the second sampling sequence and/or the third sampling sequence are within a same dimming period, in other words, the first sampling sequence refers to the sampling sequence of the drop zone within a dimming period, the second sampling sequence refers to the sampling sequence of the non-drop zone on the left side of the drop zone within the same dimming period, and the third sampling sequence refers to the sampling sequence of the non-drop zone on the right side of the drop zone within the same dimming period.

In step S103, determining the drop depth based on the first sampling sequence, as well as the second sampling sequence and/or the third sampling sequence.

That is to say, after obtaining a sampling data triggered by a vertical synchronization signal in method 100, the sampling data is determined as different sampling sequences in the drop zone, left side of the drop zone and right side of the drop zone according to the division of drop zone, each sampling sequence includes at least one sampling point, and each sampling point corresponds to a time sequence position. Therefore, when determining the drop depth, selecting different sampling sequences and different calculation methods according to actual situation to determine the drop depth, making the calculation result of the drop depth more closely related to the true result. For example, selecting different combinations of the first sampling sequence, the second sampling sequence and/or the third sampling sequence to determine the drop depth based on different factors such as the strobing of ambient light, the signal-to-noise ratio of chips or sensors.

“The first sampling sequence, as well as the second sampling sequence and/or the third sampling sequence” comprises the following situations or combinations thereof: the first sampling sequence and the second sampling sequence; the first sampling sequence and the third sampling sequence; and the first sampling sequence, the second sampling sequence and the third sampling sequence. In other words, determining the first sampling sequence, as well as the second sampling sequence and/or the third sampling sequence means determining a drop sequence and at least one non-drop sequence.

It can be seen that, in this embodiment, collecting data based on the vertical synchronization signal, and obtaining the sampling data from the drop zone of the screen leakage light waveform, as well as left side and right side of the drop zone of the screen leakage light waveform, allows for flexible selection of data from different areas for calculation when determining the drop depth of the screen leakage light waveform. Moreover, careful consideration is given to the impact from different factors such as signal-to-noise ratio and complex environmental on drop depth calculation when determining the drop depth, consequently, which helps enhance the accuracy of screen leakage light calculation and contribute to improving the accuracy of ambient light detection.

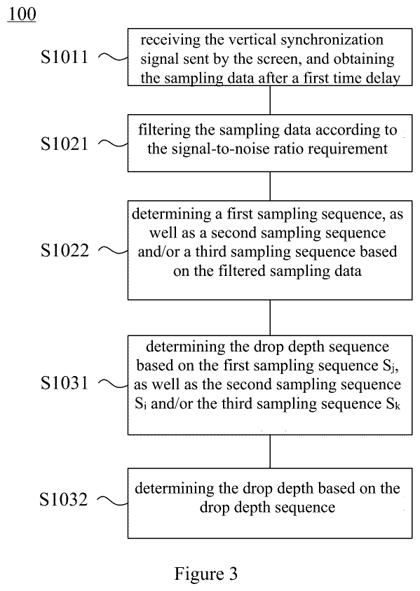

FIG. 3 is another schematic flowchart of the method 100 for determining the drop depth of screen leakage light in an embodiment of this application.

Optionally, in step S101, obtaining a sampling data based on a vertical synchronization signal comprises:

S1011, receiving the vertical synchronization signal sent by the screen, and obtaining the sampling data after a first time delay.

Specifically, due to variations in the placement of the optical sensor beneath display screens from different models or manufacturers, there exists a time disparity between the vertical synchronization signal received by the optical sensor and the sampling data it can obtain. As a result, when utilizing the vertical synchronization signal to obtain the sampling data, there is a deliberate delay after receiving the vertical synchronization signal before sampling data obtains, this delay allows optical sensors positioned at various locations beneath the display screen to accurately obtain the sampling data. For sensors located at different positions beneath the display screen, the precise value of the first time delay may differ the value can be configured based on factors such as the specific position of the sensor under display the screen.

It can be seen that, triggered by the vertical synchronization signal, obtaining the sampling data after a first time delay, is conducive to enhancing the consistency of the sampling data, so as to improve the accuracy of drop depth detection.

Optionally, in step S102, determining a first sampling sequence, as well as a second sampling sequence and/or a third sampling sequence based on the sampling data comprises:

S1021, filtering the sampling data according to the signal-to-noise ratio requirement.

S1022, determining a first sampling sequence, as well as a second sampling sequence and/or a third sampling sequence based on the filtered sampling data.

During the actual calculatational process, since inherent noise exists in devices such as optical sensors, optical sensor chips or display screens, leading to distortions of the sampling data affected by the noise. Consequently, it is advisable to filtering the sampling data according to the signal-to-noise ratio requirement this ensures that the sampling sequence used for drop depth calculation is not affected by the inherent noise originating from the devices themselves. The signal-to-noise ratio requirement includes the needs of various devices as mentioned above, such as optical sensors, optical sensor chips, display screens, and so forth. In an ideal state, the optical sensor can output stable signals. However, in reality, the signals received by optical sensors may be jitter or contain noise, to ensure stability in the output signals of the optical sensor, the signal-to-noise ratio requirement is established. The requirement is determined by the circuit architecture or circuit characteristics of the devices, such as the sensor or sensor chip, and so on. Furthermore, selective filtering of the sampling data can be performed based on the signal-to-noise ratio requirement, at least, the filtering is carried on a portion of the sampling data. For example, for a certain model of screen, when its signal-to-noise ratio requirement is known, if its inherent noise significantly affects or has an impact on the data in the drop zone, then the filtering is carried on the sampling data in the drop zone, and determines the first sampling sequence based on the filtered sampling data from the drop zone.

In this embodiment, filtering the sampling data according to the signal-to-noise ratio requirement effectively eliminates the impact of inherent noise in the equipment or device on the calculation of drop depth, consequently, it enhances the accuracy of drop depth calculation and contributes to improving the accuracy of ambient light detection.

In some embodiments, filtering includes mean filtering and/or median filtering. Wherein, mean filtering maybe a sliding mean filter within a certain window width.

In some embodiments, determining the first sampling sequence, as well as the second sampling sequence and/or the third sampling sequence based on the sampling data comprises: determining the filtered sampling data belongs to the first sampling sequence, the second sampling sequence and/or third sampling sequence based on the time sequence position corresponding to the sampling data.

Specifically, taking a dimming period for example, within this period, there are numerous sampling points distributed in time sequence order along the drop waveform of screen leakage light, according to the time sequential arrangement of these sampling points, they can be categorized into a first sampling sequence, a second sampling sequence and/or a third sampling sequence. For example, within a dimming period, there are J+I+K sampling points, according to the time sequence position, the sampling points can be divided into a first sampling sequence Sⱼ, a second sampling sequence Sᵢ and a third sampling sequence Sₖ. Wherein, j, i, and k represent the time sequence positions corresponding to the sampling points, and j, i, and k are integers and satisfy I+1≤j≤I+J, 1≤i≤I, I+J+1≤k≤I+J+K.

In this embodiment, by categorizing the sampling data into different sampling sequences, the subsequent calculation process can select appropriate data based on the actual situation, and the appropriate data is applied in the relevant calculation scheme to determine the drop depth.

Optionally, in step S103, determining the drop depth based on the first sampling sequence Sⱼ, as well as the second sampling sequence Sᵢ and/or the third sampling sequence Sₖ, comprises:

S1031, determining the drop depth sequence based on the first sampling sequence Sⱼ, as well as the second sampling sequence Sᵢ and/or the third sampling sequence Sₖ.

S1032, determining the drop depth based on the drop depth sequence.

Specifically, designing a drop depth calculation scheme that suits practical situations aimed at different factors, such as system brightness, screen dimming waveform characteristics under grayscale ambient light characteristics, and so on. Grayscale refers to the gray value of the image displayed on the screen. Based on this, by selecting different sampling sequences to determine the drop depth sequence, and then using the drop depth sequence to calculate the drop depth, it helps to improve the flexibility of the drop depth calculation, so that the drop depth determined by method 100 under different ambient lights can flexibly adapt to devices and equipments of different models and needs.

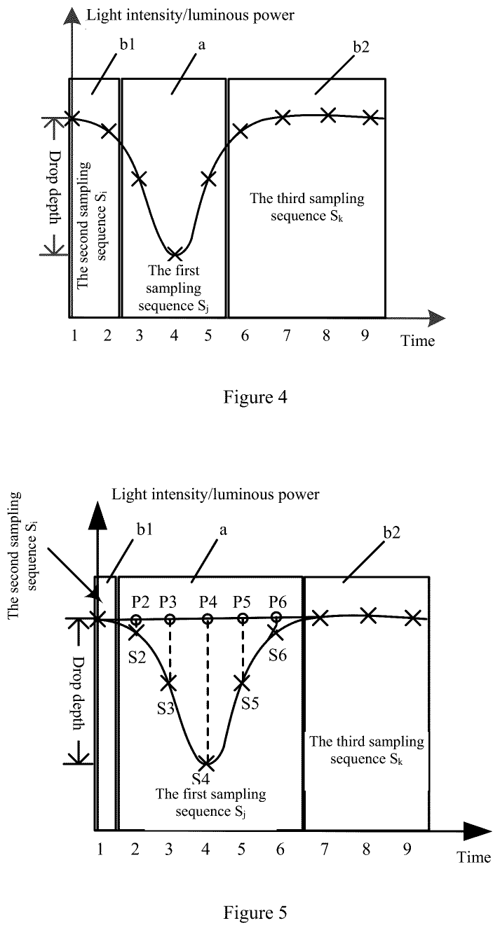

Next, let's briefly introduce the specific process of determining the drop depth sequence. FIG. 4 is a schematic diagram of a dimming waveform and sampling points in an embodiment of this application.

In S1031, determining the drop depth sequence based on the first sampling sequence Sⱼ, as well as the second sampling sequence Sᵢ and/or the third sampling sequence Sₖ comprises: determining the drop depth sequence based on the first sampling sequence Sⱼ and the second sampling sequence Sᵢ; alternatively, determining the drop depth sequence based on the first sampling sequence Sⱼ and the third sampling sequence Sₖ; alternatively, determining the drop depth sequence based on the first sampling sequence Sⱼ, the second sampling sequence Sᵢ and the third sampling sequence Sₖ.

Specifically, as illustrated in FIG. 4, when determining the drop depth sequence Dⱼ or selecting the sampling data for a calculation of the drop depth, the following options are available: selecting data from the drop zone a and the non-drop zone b₁ on the left side of the drop zone for the calculation; alternatively, selecting data from the drop zone a and the non-drop zone b₂ on the right side of the drop zone for the calculation; alternatively, selecting data from the drop zone a, the non-drop zone b₁ on the left side of the drop zone and the non-drop zone b₂ on the right side of the drop zone for the calculation.

In some embodiments, when the drop frequency of screen leakage light is higher than the ambient light strobing frequency and not in a relationship of multiplicating frequency with it, determining the drop depth sequence Dⱼ based on the first sampling sequence Sⱼ and the second sampling sequence Sᵢ, alternatively, determining the drop depth sequence Dⱼ based on the first sampling sequence Sⱼ and the third sampling sequence Sₖ.

Please continue with FIG. 4, taking an example of collecting 9 sampling points in one dimming period, the sampling data is determined as follows: the first sampling sequence Sⱼ (j=3, 4, 5), the second sampling sequence Sᵢ (i=1, 2) and the third sampling sequence Sₖ (k=6, 7, 8, 9), the lengths of the second sampling sequence, the first sampling sequence and the third sampling sequence are 2, 3 and 4, respectively. When the drop frequency of screen leakage light is higher than the strobing frequency of ambient light and not in a relationship of multiplicating frequency with it, the phase difference between the strobing ambient light and screen leakage light can be averaged across the calculations of multiple data points, thereby, accurate drop depth can be obtained by utilizing the data from the drop zone and a non-drop zone. Hence, the drop depth sequence Dⱼ can be calculated based on the first sampling sequence Sⱼ and the second sampling sequence Sᵢ, or the drop depth sequence Dⱼ can be calculated based on the first sampling sequence Sⱼ and the third sampling sequence Sₖ, where the sequence length of the drop depth sequence Dⱼ is identical to that of the first sampling sequence Sⱼ.

FIG. 5 is a schematic diagram of another dimming waveform and sampling points in an embodiment of this application.

As illustrated in FIG. 5, in some embodiments, when the drop frequency of screen leakage light is similar to the strobing frequency of ambient light or in a relationship of multiplicating frequency with it, determining the drop depth sequence Dⱼ based on the first sampling sequence Sⱼ, the second sampling sequence Sᵢ and the third sampling sequence Sₖ.

Specifically, taking the example of collecting 9 sampling points in one dimming period, the sampling data is determined as the first sampling sequence Sⱼ (j=2, 3, 4, 5, 6), the second sampling sequence Sᵢ (i=1) and the third sampling sequence Sₖ (k=7, 8, 9) the lengths of the second sampling sequence, the first sampling sequence and the third sampling sequence are 1, 5 and 3, respectively. When the drop frequency of screen leakage light is similar to the strobing frequency of ambient light or in a relationship of multiplicating frequency with it, the phase difference between strobing ambient light and screen leakage light cannot be averaged across multiple data points, thereby, interpolation operations can be employed to mitigate the influence of strobing ambient light. That means, obtaining an interpolation sequence Pⱼ from the interpolation results which calculate based on the sampling data from the second sampling sequence Sᵢ and the third sampling sequence Sₖ whose time sequence position corresponding to the first sampling sequence Sⱼ, and then calculating the accurate drop depth sequence Dⱼ by the interpolation sequence Pⱼ and the first sampling sequence Sⱼ. The sequence length of the drop depth sequence Dⱼ is the same as the first sampling sequence Sⱼ.

“The drop frequency of screen leakage light is similar to the ambient light strobing frequency” means that the absolute difference between the drop frequency of screen leakage light and the ambient light strobing frequency is less than or equal to the first threshold where the first threshold is greater than or equal to 0 and can be a fixed value or a range of values. Additionally, the first threshold can be adjusted based on factors such as the signal-to-noise ratio requirement of devices like optical sensors, optical sensor chips or display screens, as well as the specific properties of the ambient light in the environment where the display screen is settled.

It should be understood that the interpolation operation described above can be utilized to obtain the drop depth sequence Dⱼ even when the drop frequency of screen leakage light is higher than the ambient light strobing frequency and is not in a relationship of multiplicating frequency with it. Specifically, please continue with FIG. 4, taking 9 sampling points collected in one dimming period as an example, the sampling data is determined as the first sampling sequence Sⱼ (j=3, 4, 5), the second sampling sequence Sᵢ (i=1, 2) and the third sampling sequence Sₖ (k=6, 7, 8, 9), the lengths of the second sampling sequence, the first sampling sequence and the third sampling sequence are 2, 3 and 4, respectively. At this time, obtaining an interpolation sequence Pⱼ from the interpolation results which calculate based on the sampling data from the second sampling sequence Sᵢ and the third sampling sequence Sₖ, and whose time sequence position corresponding to the first sampling sequence Sⱼ, and then calculating the drop depth sequence Dⱼ by the interpolation sequence Pⱼ and the first sampling sequence Sⱼ. The sequence length of the drop depth sequence Dⱼ is the same as the first sampling sequence Sⱼ. The sequence length of the drop depth sequence Dⱼ is the same as the first sampling sequence Sⱼ. In this situation, despite the phase difference between screen leakage light and ambient light can be averaged, interpolation operations can still be utilized to accurately mitigate the influence of ambient light strobing. The method for determining the drop depth sequence Dⱼ in different situations mentioned above serves merely as an example, the method for determining the drop depth sequence Dⱼ can be selected based on factors, such as data accuracy, calculatational complexity, and so on.

In some embodiments, determining the drop depth sequence Dⱼ based on the first sampling sequence Sⱼ and the second sampling sequence Sᵢ comprises: determining a first maximum value L1 as the average value of the sampling data corresponding to M sampling points near the first time sequence position iₛₑₜ in the second sampling sequence Sᵢ, wherein M is a positive integer; and calculating the difference between the first maximum value L1 and the first sampling sequence Sⱼ to determine the drop depth sequence Dⱼ.

Specifically, when determining the drop depth sequence Dⱼ, the sampling data corresponding to M sampling points near the first time sequence position iₛₑₜ can be selected in the second sampling sequence Sᵢ, and taking the average value of the M sampling data as the first maximum value L1. Obtaining the drop depth sequence Dⱼ by subtracting each sampling data in the first sampling sequence Sⱼ L1 from the first maximum value respectively. When M is set to 1, selecting the sampling data corresponding to the first time sequence position iₛₑₜ as the first maximum value L1.

In some embodiments, determining the drop depth sequence Dⱼ based on the first sampling sequence Sⱼ and the second sampling sequence Sᵢ comprises: determining the first maximum value L1 as the average value of the sampling data corresponding to M sampling points near the time sequence position iₘₐₓ corresponding to the sampling data with the maximum numerical value in the second sampling sequence Sᵢ, wherein M is a positive integer; and calculating the difference between the first maximum value L1 and the first sampling sequence Sⱼ to determine the drop depth sequence Dⱼ.

Specifically, when determining the drop depth sequence Dⱼ, calculating the average value of M sampling data as the first maximum value L1, wherein the M sampling data can be selected from the time sequence position iₘₐₓ which corresponds to the sampling data with the maximum value in the second sampling sequence Sᵢ. Obtaining the drop depth sequence Dⱼ by subtracting each sampling data in the first sampling sequence Sⱼ from the first maximum value L1 respectively. When M is set to 1, selecting the sampling data with the maximum numerical value in the second sampling sequence Sᵢ as the first maximum value L1.

It can be understood that, the first maximum value L1 described above can be utilized to characterize the light intensity or luminous power of the second sampling sequence Sᵢ on the left side of the drop zone.

In some embodiments, determining the drop depth sequence Dⱼ based on the first sampling sequence Sⱼ and the third sampling sequence Sₖ comprises: determining a second maximum value L2 as the average value of the sampling data corresponding to N sampling points near the second time sequence position kₛₑₜ in the third sampling sequence Sₖ, wherein N is a positive integer; and calculating the difference between the second maximum value L2 and the first sampling sequence Sⱼ to determine the drop depth sequence Dⱼ.

Specifically, when determining the drop depth sequence Dⱼ, selecting the sampling data corresponding to N sampling points near the second time sequence position kₛₑₜ from the third sampling sequence Sₖ, and taking the average value of the N sampling data as the second maximum value L2. Obtaining the drop depth sequence Dⱼ by subtracting each sampling data in the first sampling sequence Sⱼ from the second maximum value L2. When N is set as 1, selecting the sampling data corresponding to the second time sequence position kₛₑₜ as the second maximum value L2.

In some embodiments, determining the drop depth sequence Dⱼ based on the first sampling sequence Sⱼ and the third sampling sequence Sₖ comprises: determining a second maximum value L2 as the average value of the sampling data corresponding to N sampling points near the time sequence position kₘₐₓ which corresponds to the sampling data with the maximum numerical value in the third sampling sequence Sₖ, wherein N is a positive integer; and calculating the difference between the second maximum value L2 and each sampling data in the first sampling sequence Sⱼ to determine the drop depth sequence Dⱼ.

Specifically, when determining the drop depth sequence Dⱼ, taking the average value of the sampling data corresponding to N sampling points near the time sequence position kₘₐₓ which corresponds to the sampling data with the maximum numerical value in the third sampling sequence Sₖ as the second maximum value L2. Obtaining the drop depth sequence Dⱼ by subtracting each sampling data in the first sampling sequence Sⱼ from the second maximum value L2. When N is set to 1, selecting the sampling data with the maximum numerical value in the third sampling sequence Sₖ as the second maximum value L2.

It can be understood that, the second maximum value L2 described above can be utilized to characterize the light intensity or luminous power of the third sampling sequence Sₖ on the right side of the drop zone.

In some embodiments, determining the drop depth sequence Dⱼ based on the first sampling sequence Sⱼ, the second sampling sequence Sᵢ and the third sampling sequence Sₖ comprises: calculating the interpolation operation results of the second sampling sequence Sᵢ and the third sampling sequence Sₖ at the time sequence positions corresponding to the first sampling sequence Sⱼ to obtain a fourth sampling sequence Pⱼ; calculating the difference between the fourth sampling sequence Pⱼ and the first sampling sequence Sⱼ to determine the drop depth sequence Dⱼ.

Specifically, when determining the drop depth sequence Dⱼ, performing interpolation operations on the values of the sampling data at the time sequence positions corresponding time sequence positions i, k in the second sampling sequence Sᵢ and the third sampling sequence Sₖ and the values of the sampling data at the time sequence positions corresponding time sequence positions j in the first sampling sequence Sⱼ, and obtaining a fourth sampling sequence Pⱼ, where the sequence length of the fourth sampling sequence Pⱼ is equal to that of the first sampling sequence Sⱼ. Obtaining the drop depth sequence Dⱼ by calculating the difference between the fourth sampling sequence Pⱼ and the first sampling sequence Sⱼ at the same time sequence position j. Please continue with FIG. 5, taking 9 sampling points collected in one dimming period as an example, the sampling data is determined as the first sampling sequence Sⱼ (j=2, 3, 4, 5, 6), the second sampling sequence Sᵢ (i=1) and the third sampling sequence Sₖ (k=7, 8, 9), determining the fourth sampling sequence Pⱼ at positions j=2, 3, 4, 5, and 6 through interpolation operation based on S₁, S₇, S₈ and S₉, as well as i=1, k=7, 8, and 9 is determined; and then obtaining the drop depth sequence Dⱼ (j=2, 3, 4, 5, 6) based on D2=P2−S2, D3=P3−S3, D4=P4−S4, D5=P5−S5, D6=P6−S6.

In some embodiments, interpolation operations include at least one of linear interpolation, cubic spline interpolation and polynomial interpolation techniques.

Therefore, the drop depth sequence Dⱼ obtained by selecting different sampling sequences and using different drop depth algorithms can be as closely as possible to the true drop depth. Furthermore, after obtaining the drop depth sequence Dⱼ, determining the final drop depth utilized in the calculation of the “screen leakage light drop depth—leakage light amount” model through different schemes.

In some embodiments, determining the drop depth based on the drop depth sequence Dⱼ comprises: determining the drop depth based on the fixed data in the drop depth sequence Dⱼ; alternatively, determining the drop depth based on the changed data in the drop depth sequence Dⱼ.

Specifically, after obtaining the drop depth sequence Dⱼ, selecting the data of the drop depth sequence Dⱼ for the calculation of the “screen leakage light drop depth—screen leakage light amount” model. For instance, in the case of the model is relatively complex, selecting the fixed data to determine the drop depth, which can reduce overall calculational complexity and enhance calculational efficiency. In the case of the model is relatively simple, selecting the changed data to determine the drop depth, makes the calculated value of the leakage light be closer to true value. For example, the fixed data in the drop depth sequence Dⱼ could be data corresponding to fixed time sequence positions, all data in the drop depth sequence Dⱼ or data corresponding to a fixed number of entries in the drop depth sequence Dⱼ. For example, the changed data in the drop depth sequence Dⱼ could be maximum numerical values, medians of partial data points, and so on.

In some embodiments, determining the drop depth based on the fixed data in the drop depth sequence Dⱼ comprises: determining all data within the drop depth sequence Dⱼ as the drop depth. In other words, all data in the drop depth sequence Dⱼ is utilized for the calculation of the leakage light amount in the “screen leakage light drop depth—leakage amount” model.

In some embodiments, determining the drop depth based on the fixed data in the drop depth sequence Dⱼ comprises: obtaining a weight coefficient sequence θⱼ whose length is corresponding to the length of the drop depth sequence Dⱼ, and determining the drop depth as the average value of the product of each data in the drop depth sequence Dⱼ and that in the corresponding weight coefficient sequence θⱼ. Namely, the average value of Dⱼ*θⱼ is the drop depth.

Specifically, for example, PWM dimming requires to adjust not only the luminous power of drop zone and non-drop zone to regulate screen brightness but also the proportion of non-drop zone within a dimming period to regulate the average luminous power. Since the situation of the same drop depth corresponding to different amounts of leakage light exists at this time, a significant amount of detailed data from drop depth sequence Dⱼ participating in the calculation of leakage light amount in the model is necessary. Alternatively, for the drop depth sequence Dⱼ, smaller drop depths result in lower signal-to-noise ratios for their values, leading to greater errors (such as, jitter error, and so on) in the calculation of leakage light amount. At this moment, it is advisable to make each value in the drop depth sequence Dⱼ to correspond with a weight coefficient by designing a weight coefficient sequence θⱼ, controlling values with low signal-to-noise ratios in the drop depth sequence Dⱼ and small weight coefficients from θⱼ to calculate, while values with high signal-to-noise ratios in the drop depth sequence Dⱼ and large weight coefficients from θⱼ to calculate, furthermore, the weights of the values with low signal-to-noise ratio in Dⱼ are reduced and the weights of the values with high signal-to-noise ratio in Dⱼ are amplified, thereby enhancing the overall signal-to-noise ratio of the drop depth used for model calculations.

In some embodiments, determining the drop depth based on the fixed data in the drop depth sequence Dⱼ comprises: determining the drop depth as the average value of all data in the drop depth sequence Dⱼ.

In some embodiments, determining the drop depth based on the fixed data in the drop depth sequence Dⱼ comprises: determining the drop depth as the average value of m data near the third time sequence position jₛₑₜ in the drop depth sequence Dⱼ, wherein m is a positive integer.

In some embodiments, when the screen leakage light drop waveform is consistent, determining the drop depth by the fixed data in the drop depth sequence Dⱼ. When the consistency of the screen leakage light drop waveform is good, the data difference between different dimming periods is small, thereby it is advisable to select the method for determining the drop depth by the fixed data described above, which can reduce the calculatational complexity of calculating the leakage light amount while ensuring the accuracy of it.

As an illustrative example, please continue with FIG. 4, when the consistency of the screen leakage light drop waveform is good, it is advisable to select the sampling value at time sequence position i=1 in the second sampling sequence Sᵢ as the first maximum value L1 fixedly; and obtaining a drop depth sequence Dⱼ by subtracting the sampling values of each time sequence position in the first sampling sequence Sⱼ from L1, in addition, selecting the value at time sequence position j=4 in Dⱼ as the final drop depth output fixedly.

In some embodiments, determining the drop depth based on the changed data in the drop depth sequence Dⱼ comprises: determining the drop depth as the average value of the top n data in the drop depth sequence Dⱼ whose values are arranged in descending order, wherein n is a positive integer.

In some embodiments, determining the drop depth based on the changed data in the drop depth sequence Dⱼ comprises: determining the drop depth as the average value of h data values near the time sequence position corresponding to the data with the maximum numerical value in the drop depth sequence Dⱼ, wherein h is a positive integer.

Specifically, take a DC dimming for example, in DC dimming, the proportions of drop zone and non-drop zone in one dimming period usually remain constant, adjusting the average power by proportionally regulating the power of the drop zone and the non-drop zone, in this situation, there exists a nearly linear relationship between the drop depth and the average power. Simultaneously, when the amount of leakage light is constant, a larger drop depth results in higher accuracy of calculating the leakage light. Therefore, for methods used in model of DC dimming, it is advisable to select the method for determining the drop depth that makes the final drop depth used for calculation larger.

In some embodiments, when the screen leakage light drop waveform is not consistent, determing the drop depth by the changed data in the drop depth sequence. When the consistency of the screen leakage light drop waveform is poor, there is significant difference in data between different dimming periods; it is advisable to utilize the method of determining the drop depth based on the changed data as described above for further enhancing the accuracy of leakage light amount calculation.

As an illustrative example, please continue with FIG. 4, when the consistency of the screen leakage light drop waveform is poor, it is advisable to search the maximum numerical value in the second sampling sequence Sᵢ dynamically, for example, if the sampling value at time sequence position i=1 is the maximum numerical value, taking the sampling value at time sequence position i=1 as the first maximum value L1; obtaining a drop depth sequence Dⱼ by subtracting the sampling values of each time sequence position in the first sampling sequence Sⱼ from L1; and searching the maximum numerical value in Dⱼ as final drop depth output dynamically. For example, the value at time sequence position j=4 in the drop depth sequence Dⱼ is the maximum numerical value, selecting the value at time sequence position j=4 as the final drop depth output.

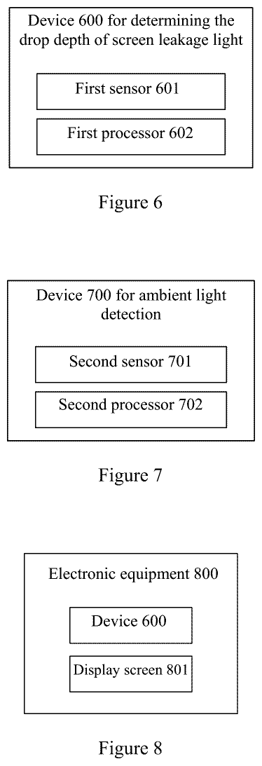

This embodiment of this application also provides a device for determining the drop depth of screen leakage light. FIG. 6 is a schematic structural diagram of the device 600 used to determine the drop depth of screen leakage light.

Referring to FIG. 6, device 600 comprises a first sensor 601 and a first processor 602. Wherein, the first sensor 601 is utilized to obtaining sampling data based on a vertical synchronization signal; the first processor 602 is utilized to determine the first sampling sequence Sⱼ, as well as the second sampling sequence Sᵢ and/or the third sampling sequence Sₖ based on the sampling data; and the first processor 602 is also utilized to determine the drop depth based on the first sampling sequence Sⱼ, as well as the second sampling sequence Sᵢ and/or the third sampling sequence Sₖ.

The first sampling sequence Sⱼ is a sampling sequence of the drop zone of the screen leakage light drop waveform, the second sampling sequence Sᵢ is a sampling sequence of the left side of the drop zone of the screen leakage light drop waveform, and the third sampling sequence Sₖ is a sampling sequence of the right side of the drop zone of the screen leakage light drop waveform. It can be understood that, the first sampling sequence, the second sampling sequence and/or the third sampling sequence are within the same dimming period, in other words, the first sampling sequence is the sampling sequence of the drop zone within one dimming period, the second sampling sequence is the sampling sequence of the non-drop zone on the left side of the drop zone within the same dimming period, and the third sampling sequence is the sampling sequence of the non-drop zone on the right side of the drop zone within the same dimming period.

In some embodiments, the first sensor 601 is utilized to receive the vertical synchronization signal sent by the screen, and obtain the sampling data after a first time delay.

In some embodiments, the first processor 602 is utilized to filter the sampling data based on a signal-to-noise ratio requirement; and the first processor 602 is also utilized to determine the first sampling sequence Sⱼ, as well as the second sampling sequence Sᵢ and/or the third sampling sequence Sₖ based on the filtered sampling data.

In some embodiments, the signal-to-noise ratio requirement includes signal-to-noise ratio of the screen and signal-to-noise ratio of the device.

In some embodiments, the first processor 602 is utilized to determine the filtered sampling data belongs to the first sampling sequence Sⱼ, the second sampling sequence Sᵢ and/or the third sampling sequence Sₖ according to the time sequence position corresponding to the sampling data.

In some embodiments, filtering includes at least one of mean filtering and median filtering.

In some embodiments, the first processor 602 is utilized to determine a drop depth sequence Dⱼ based on the first sampling sequence Sⱼ, as well as the second sampling sequence Sᵢ and/or the third sampling sequence Sₖ; and the first processor 602 is also utilized to determine the drop depth based on the drop depth sequence Dⱼ.

In some embodiments, the first processor 602 is utilized to determine the drop depth sequence Dⱼ based on the first sampling sequence Sⱼ and the second sampling sequence Sᵢ; alternatively, the first processor 602 is utilized to determine the drop depth sequence Dⱼ based on the first sampling sequence Sⱼ and the third sampling sequence Sₖ; alternatively, the first processor 602 is utilized to determine the drop depth sequence Dⱼ based on the first sampling sequence Sⱼ, the second sampling sequence Sᵢ and the third sampling sequence Sₖ.

In some embodiments, when the drop frequency of screen leakage light is higher than the ambient light strobing frequency and the drop frequency of screen leakage light is not in a relationship of multiplicating frequency with the ambient light strobing frequency, the first processor 602 is utilized to determine the drop depth sequence Dⱼ based on the first sampling sequence Sⱼ and the second sampling sequence Sᵢ; alternatively, the first processor 602 is utilized to determine the drop depth sequence Dⱼ based on the first sampling sequence Sⱼ and the third sampling sequence Sₖ.

In some embodiments, when the drop frequency of screen leakage light is similar to the ambient light strobing frequency or when the drop frequency of screen leakage light is in a relationship of multiplicating frequency with the ambient light strobing frequency, the first processor 602 is utilized to determine the drop depth sequence Dⱼ based on the first sampling sequence Sⱼ, the second sampling sequence Sᵢ and the third sampling sequence Sₖ.

In some embodiments, the first processor 602 is utilized to determine a first maximum value L1 as the average value of the sampling data corresponding to M sampling points near the first time sequence position iₛₑₜ in the second sampling sequence Sᵢ, and the first processor 602 is also utilized to calculate the difference between the first maximum value L1 and the first sampling sequence Sⱼ to determine the drop depth sequence Dⱼ, wherein M is a positive integer.

In some embodiments, the first processor 602 is utilized to determine the first maximum value L1 as the average value of the sampling data corresponding to M sampling points near the time sequence position iₘₐₓ corresponding to the sampling data with the maximum numerical value in the second sampling sequence Sᵢ, and the first processor 602 is also utilized to calculate the difference between the first maximum value L1 and the first sampling sequence Sⱼ to determine the drop depth sequence Dⱼ, wherein M is a positive integer.

In some embodiments, the first processor 602 is utilized to determine a second maximum value L2 as the average value of the sampling data corresponding to N sampling points near the second time sequence position kₛₑₜ in the third sampling sequence Sₖ, and the first processor 602 is also utilized to calculate the difference between the second maximum value L2 and the first sampling sequence Sⱼ to determine the drop depth sequence Dⱼ, wherein N is a positive integer.

In some embodiments, the first processor 602 is utilized to determine a second maximum value L2 as the average value of the sampling data corresponding to N sampling points near the time sequence position kₘₐₓ corresponding to the sampling data with the maximum numerical value in the third sampling sequence Sₖ, and the first processor 602 is also utilized to calculate the difference between the second maximum value L2 and the first sampling sequence Sⱼ to determine the drop depth sequence Dⱼ, wherein N is a positive integer.

In some embodiments, the first processor 602 is utilized to calculate the interpolation operation results of the second sampling sequence Sᵢ and the third sampling sequence Sₖ at the time sequence position i corresponding to the first sampling sequence Sⱼ to obtain a fourth sampling sequence Pⱼ, and the first processor 602 is also utilized to calculate the difference between the fourth sampling sequence Pⱼ and the first sampling sequence Sⱼ to determine the drop depth sequence Dⱼ.

In some embodiments, interpolation operations include at least one of linear interpolation operations, cubic spline interpolation operations and polynomial interpolation operations.

In some embodiments, the first processor 602 is utilized to determine the drop depth by the fixed data in the drop depth sequence Dⱼ; alternatively, the first processor 602 is utilized to determine the drop depth by the changed data in the drop depth sequence Dⱼ.

In some embodiments, the first processor 602 is utilized to determine the drop depth as all data in the drop depth sequence Dⱼ; alternatively, the first processor 602 is utilized to determine the drop depth as the average value of the data in the drop depth sequence Dⱼ; alternatively, the first processor 602 is utilized to determine the drop depth as the average value of m data points near the third time sequence position jₛₑₜ in the drop depth sequence Dⱼ, wherein m is a positive integer; alternatively, the first processor 602 is utilized to obtain a weight coefficient sequence θⱼ whose length is corresponding to the drop depth sequence Dⱼ, and the first processor 602 is also utilized to determine the drop depth as the average value of the product of each data in the drop depth sequence Dⱼ and its corresponding weight coefficient sequence θⱼ.

In some embodiments, the first processor is utilized to determine the drop depth as the average value of the top n data in the drop depth sequence Dⱼ whose values are arranged in descending order, wherein n is a positive integer; alternatively, the first processor 602 is utilized to determine the drop depth as the average value of h data near the time sequence position corresponding to the data with the maximum numerical value in the drop depth sequence is the drop depth, wherein h is a positive integer.

In some embodiments, when the screen leakage light drop waveform is consistent, the first processor 602 is utilized to determine the drop depth by the fixed data in the drop depth sequence Dⱼ; when the screen leakage light drop waveform is not consistent, the first processor 602 is utilized to determine the drop depth by the changed data in the drop depth sequence Dⱼ.

In summary, the device 600 provided in this application embodiment for determining the drop depth of screen leakage light can implement the method 100 for determining the drop depth of screen leakage light corresponding to the method embodiments as described above, and the device 600 also possesses the beneficial effects corresponding to the method embodiments as described above, which will not be repeated here.

In addition, the embodiment of this application also provides a device for detecting ambient light. FIG. 7 is a schematic structural diagram of the device 700 for detecting ambient light.

Referring to FIG. 7, the device 700 for detecting ambient light comprises a second sensor 701, a second processor 702 and a device 600 for determining the drop depth of screen leakage light.

Specifically, the second sensor 701 is utilized to obtain collected light data, which includes ambient light data and screen leakage light data. The second processor 702 is utilized to obtain screen leakage light data and calculate the difference between the collected light data and the screen leakage light data to detect ambient light, where the screen leakage light data can be calculated based on the screen leakage light drop depth—screen leakage light amount model in the method embodiments as described above. The device 600 for determining the drop depth of screen leakage light is utilized to detect the drop depth of screen leakage light.

In some embodiments, the device 700 for detecting ambient light may only include at he device 600 for determining the drop depth of screen leakage light. At this point, the second sensor 701 can be the first sensor 601, and the second processor 702 can be the first processor 602.

The embodiment of this application also provides an electronic equipment. FIG. 8 shows a schematic structural diagram of an electronic equipment 800. As shown in FIG. 8, the electronic equipment 800 comprises a display screen 801 and a device 600 for determining the drop depth of screen leakage light, the device 600 is located below the display screen 801 and can be utilized to determine the drop depth, and the device 600 also can be utilized to calculate the screen leakage light amount based on the screen leakage light drop depth—screen leakage light amount model in the method embodiments as described above, furthermore, the light detection of ambient is implemented.

The first processor 602 and the second processor 702 described in the embodiment of this application may include one or more processing cores. The first processor 602 and the second processor 702 are connected to the first sensor 601 and the second sensor 701 through various interfaces and circuits, simultaneously, the first processor 602 and the second processor 702 perform various functions and process data of the device 600 or device 700 by running or executing the instructions, programs, code sets or instruction sets stored in memory and calling data stored in the memory.

Optionally, the first processor 602 and the second processor 702 can be implemented in at least one hardware form, including Digital Signal Processing (DSP), Field Programmable Gate Array (FPGA) or Programmable Logic Array (PLA). The first processor 602 and the second processor 702 can integrate into one or several of central processing unit (CPU), graphics processing unit (GPU) and modem.

The first sensor 601 and the second sensor 701 can be any photosensitive component used for collecting light to detect light intensity, the specific photosensitive sensors are not limited here.

As an example rather than a limitation, the electronic equipment 800 in the embodiment of this application can be any portable or mobile computing devices such as terminal devices, mobile phones, tablets, laptops, desktop computers, gaming devices, in-car electronic devices or wearable smart devices, as well as any other electronic equipment such as electronic databases, cars and bank automated teller machines (ATMs). The wearable smart device can be fully functional and large in size, capable of achieving complete or partial functionality without relying on a smartphone, such as smart watches or smart glasses. Alternatively, the wearable smart device may focus only on a certain type of application function and require coordination with other devices such as smartphones, including smart bracelets and smart jewelry for monitoring physical signs, and so on.

Display screen 801 can be utilized to display information input by users or provided to users, as well as various graphical user interfaces of electronic equipment, these graphical user interfaces can be comprised of images, text, icons, videos and any combination of them. In some embodiments, the first processor 602 and the second processor 702 may obtain detection light intensity values based on the light received by the first sensor 601 and the second sensor 701. Subsequently, the first processor 602 and the second processor 702 can determine the current ambient light intensity value based on the detected light intensity value, and adjust the brightness of the display screen 801 based on the current ambient light intensity value.

Optionally, the display screen 801 can be an OLED display screen. Specifically, the oganic light emitting diode (OLED) display screen has good transparency, through which visible light can pass. Therefore, the OLED display screen does not affect the visible light received by the first sensor 601 and the second sensor 701 while displaying the content effect. It should be understood that the OLED display screen is only for an example, the embodiments of this application are not limited to this.

It should be noted that, without conflict, the embodiments and/or the technical features of embodiments described in this application can be arbitrarily combined with each other, the technical solution obtained after combination should also fall within the scope of protection of this application.

The devices and methods disclosed in the embodiments of this application may be implemented in other ways. For example, some features of the method embodiments described above can be ignored or not executed. The device embodiments described above are only illustrative, and the division of units is only a logical function division, in actual implementation, there may be other division methods, where multiple units or components can be combined or integrated into another system. In addition, couple of each unit or component can be directly coupled or indirectly coupled, the couple includes the connection of electrically, mechanically or other forms.

The modules described as separate components in this application may or may not be physically separated, the components displayed as modules may or may not be physical modules. Furthermore, in the various embodiments of this application, each functional module in the embodiments of this application can be integrated into one processing unit; alternatively, exist physically separately; alternatively, be integrated into one unit by two or more modules.

The above description refers to only the specific embodiments of the application, however, the scope of protection of the application is not limited to these embodiments, any modifications or substitutions can be easily figured out by those skilled in the art within the disclosed technical scope of the application, and these modifications or substitutions should also be covered within the scope of protection of this application. Therefore, the scope of protection of the application should be based on the scope of protection of the claims.

What is claimed is:

1. A method for determining the drop depth of screen leakage light, the method comprising:
obtaining a sampling data based on a vertical synchronization signal;
determining a first sampling sequence, as well as a second sampling sequence and/or a third sampling sequence based on the sampling data, the first sampling sequence is the sampling sequence of the drop zone of the screen leakage light drop waveform, the second sampling sequence is the sampling sequence on the left side of the drop zone of the screen leakage light drop waveform, and the third sampling sequence is the sampling sequence on the right side of the drop zone of the screen leakage light drop waveform;
determining the drop depth based on the first sampling sequence, as well as the second sampling sequence and/or the third sampling sequence.

2. The method according to claim 1, wherein the obtaining a sampling data based on a vertical synchronization signal comprising:
receiving a vertical synchronization signal sent by the screen,
obtaining the sampled data after a first time delay.

3. The method according to claim 1, wherein the determining a first sampling sequence, as well as a second sampling sequence and/or a third sampling sequence based on the sampling data comprising:
filtering the sampling data according to a signal-to-noise ratio requirement;
determining the first sampling sequence, as well as the second sampling sequence and/or the third sampling sequence based on the filtered sampling data.

4. The method according to claim 1, wherein the determining the drop depth based on the first sampling sequence, as well as the second and/or third sampling sequences comprising:
determining a drop depth sequence based on the first sampling sequence, as well as the second sampling sequence and/or the third sampling sequence;
determining the drop depth based on the drop depth sequence.

5. The method according to claim 4, wherein the determining a drop depth sequence based on the first sampling sequence, as well as the second sampling sequence and/or the third sampling sequence comprising:
determining the drop depth sequence based on the first sampling sequence and the second sampling sequence; alternatively,
determining the drop depth sequence based on the first sampling sequence and the third sampling sequence; alternatively,
determining the drop depth sequence based on the first sampling sequence, the second sampling sequence and the third sampling sequence.

6. The method according to claim 5, when the drop frequency of the screen leakage light is higher than the ambient light strobing frequency and the drop frequency of the screen leakage light is not in a relationship of multiplicating frequency with the ambient light strobing frequency, determining the drop depth sequence based on the first sampling sequence and the second sampling sequence; alternatively, determining the drop depth sequence based on the first sampling sequence and the third sampling sequence.

7. The method according to claim 5, when the drop frequency of the screen leakage light is similar to the ambient light strobing frequency, or when the drop frequency of the screen leakage light is in a relationship of multiplicating frequency with the ambient light strobing frequency, determining the drop depth sequence based on the first sampling sequence, the second sampling sequence and the third sampling sequence.

8. The method according to claim 5, wherein the determining the drop depth sequence based on the first sampling sequence and the second sampling sequence comprising:
determining a first maximum value as the average value of the sampling data corresponding to M sampling points near the first time sequence position in the second sampling sequence, wherein M is a positive integer; alternatively,
determining a first maximum value as the average value of the sampling data corresponding to M sampling points near the time sequence position of the sampling data with the maximum numerical value in the second sampling sequence, wherein M is a positive integer;
and calculating the difference between the first maximum value and the first sampling sequence to determine the drop depth sequence.

9. The method according to claim 5, wherein the determining the drop depth sequence based on the first sampling sequence and the third sampling sequence comprising:
determining a second maximum value as the average value of the sampling data corresponding to N sampling points near the second time sequence position in the third sampling sequence, wherein N is a positive integer; alternatively,
determining a second maximum value as the average value of the sampling data corresponding to N sampling points near the time sequence position which corresponds to the sampling data with the maximum numerical value in the third sampling sequence, wherein N is a positive integer;
and calculating the difference between the second maximum value and the first sampling sequence to determine the drop depth sequence.

10. The method according to claim 5, wherein the determining the drop depth sequence based on the first sampling sequence, the second sampling sequence and the third sampling sequence comprising:
calculating the interpolation operation result of the second sampling sequence and the third sampling sequence at the time sequence position corresponding to the first sampling sequence to obtain a fourth sampling sequence;
and calculating the difference between the fourth sampling sequence and the first sampling sequence to determine the drop depth sequence.

11. The method according to claim 4, wherein the determining the drop depth based on the drop depth sequence comprising:
determining the drop depth based on the fixed data in the drop depth sequence; alternatively,
determining the drop depth based on the changed data in the drop depth sequence.

12. The method according to claim 11, wherein the determining the drop depth based on the fixed data in the drop depth sequence comprising:
determining the drop depth as all data in the drop depth sequence; alternatively,
determining the drop depth as the average value of all data in the drop depth sequence; alternatively,
determining the drop depth as the average of m data near the third time sequence position in the drop depth sequence, wherein m is a positive integer; alternatively,
obtaining a weight coefficient sequence whose sequence length is corresponding to the length of the drop depth sequence, and determining the drop depth as the average value of the product of each data in the drop depth sequence and that in the corresponding weight coefficient sequence.

13. The method according to claim 11, wherein the determining the drop depth based on the changed data in the drop depth sequence comprising:
determining the drop depth as the average value of the top n data in the drop depth sequence whose values are arranged in descending order, wherein n is a positive integer; alternatively,
determining the drop depth as the average value of h data near the time sequence position corresponding to the data with the maximum numerical value in the drop depth sequence, wherein h is a positive integer.

14. The method according to claim 11, when the screen leakage light drop waveform is consistent, determining the drop depth based on the fixed data in the drop depth sequence; alternatively,
when the screen leakage light drop waveform is not consistent, determining the drop depth based on the changed data in the drop depth sequence.

15. A device for determining the drop depth of screen leakage light, the device comprising:
a first sensor, the first sensor is utilized to obtain sampling data based on a vertical synchronization signal;
a first processor, the first processor is utilized to determine the first sampling sequence, as well as the second sampling sequence and/or the third sampling sequence based on the sampling data; and determine the drop depth based on the first sampling sequence, as well as the second sampling sequence and/or third sampling sequence;
wherein, the first sampling sequence is the sampling sequence of the drop zone of the screen leakage light drop waveform, the second sampling sequence is the sampling sequence on the left side of the drop zone of the screen leakage light drop waveform, the third sampling sequence is the sampling sequence on the right side of the drop zone of the screen leakage light drop waveform.

16. The device according to claim 15, the first sensor is utilized to receive a vertical synchronization signal sent by the screen, and obtain the sampled data after a first time delay.

17. The device according to claim 15, the first processor is utilized to filter the sampling data according to a signal-to-noise ratio requirement; and determining the first sampling sequence, as well as the second sampling sequence and/or the third sampling sequence based on the filtered sampling data.

18. The device according to claim 15, the first processor is utilized to determine a drop depth sequence based on the first sampling sequence, as well as the second sampling sequence and/or the third sampling sequence; and determining the drop depth based on the drop depth sequence.

19. The device according to claim 18, the first processor is utilized to determine the drop depth sequence based on the first sampling sequence and the second sampling sequence; alternatively,
determine the drop depth sequence based on the first sampling sequence and the third sampling sequence; alternatively,
determine the drop depth sequence based on the first sampling sequence, the second sampling sequence and the third sampling sequence.

20. The device according to claim 18, wherein the determining the drop depth based on the drop depth sequence comprising:
the first processor is utilized to determine the drop depth based on the fixed data in the drop depth sequence; alternatively,
the first processor is utilized to determine the drop depth based on the changed data in the drop depth sequence.

21. The device according to claim 20, when the screen leakage light drop waveform is consistent, the first processor is utilized to determine the drop depth based on the fixed data in the drop depth sequence; alternatively,
when the screen leakage light drop waveform is not consistent, the first processor is utilized to determine the drop depth based on the changed data in the drop depth sequence.

22. A device for detecting ambient light, the device comprising: a second sensor, the second sensor is utilized to obtain collected light data, the collected light data includes ambient light data and screen leakage light data;
a second processor, the second processor is utilized to obtain the screen leakage light data and calculate the difference between the collected light data and the screen leakage light data for detecting ambient light, herein, the screen leakage light data is derived from the model based on the drop depth of screen leakage light and the amount of screen leakage light;
the device for determining the drop depth of screen leakage light as described in claim 15, which is utilized to detect the drop depth of screen leakage light.

23. An electronic equipment, the electronic equipment comprises: a display screen, as well as
the device for determining the drop depth of screen leakage light as described in claim 15, which is positioned beneath the display screen and is utilized for ambient light detection.
